(19) United States
(12) Patent Application Publication
(10) Pub. No.: US 2026/0267743 A1
(43) Pub. Date: Sep. 10, 2026

(54) STORAGE SYSTEM AND DATA PROTECTION METHOD

(71) Applicant: Hitachi Vantara, Ltd., Kanagawa-ken (JP)

(72) Inventors: Takashi NAGAO, Tokyo (JP); Sadahiro SUGIMOTO, Tokyo (JP); Norio SHIMOZONO, Tokyo (JP)

(21) Appl. No.: 19/325,249

(22) Filed: Sep. 10, 2025

(30) Foreign Application Priority Data
Mar. 6, 2025 (JP) 2025-035433

(51) Int. Cl. G06F 11/14

(52) U.S. Cl. CPC G06F 11/1448; G06F 11/1464; G06F 11/1469

(57) ABSTRACT

Data protection performance of a storage system during maintenance thereof is improved. A storage system includes a first memory protection method, which duplicates data in a memory into a memory of a corresponding one of storage controllers, and a second memory protection method, which generates a log related to update of the data in the memory and writes the log into a storage device, starts, when receiving a maintenance work instruction that requires the first storage controller to be shut down, an operation of protecting cached data according to the second memory protection method, while the second storage controller protects the cached data according to the first memory protection method, ends the protection of the cached data according to the first memory protection method when a status is established in which the cached data is protected according to the second memory protection method, and shuts down the first storage controller.

### CROSS REFERENCE TO RELATED APPLICATION

This application relates to and claims the benefit of priority from Japanese Patent Application number 2025-035433, filed on Mar. 6, 2025 the entire disclosure of which is incorporated herein by reference.

### BACKGROUND OF THE INVENTION

### 1. Field of the Invention

The present invention relates to a storage system and a data protection method.

### 2. Description of the Related Art

A storage system records write data received from a host to a drive via a cache memory (hereinafter referred to as the cache). In other words, the write data requested to be written of the host is temporarily held in the cache, and then written to a predetermined drive. Methods of writing data from the cache to the drive can be roughly divided into two types.

One of the methods is, e.g., a so-called write-through method, which writes the write data to the drive before returning a response to a write request to the host. Another of the methods is, e.g., a so-called write-back or write-after method, which returns the response to the write request to the host at a time when the write data is stored in the cache. In a case of the write-back method, the writing of the write data to the drive is performed with predetermined timing after the storage of the write data in the cache.

In general, the time required to store data in the cache is shorter than the time required to write data to the drive. Therefore, the write-back method is advantageous over the write-through method in that the time required to respond to the host is shorter in the write-back method.

In particular, in the write-through method for a drive belonging to a RAID configuration, it is necessary not only to write the write data, but also to read, from the drive, the write data and parity data before the write request for calculating code data (hereinafter referred to as the parity data) for data recovery in the event of a drive failure and write the parity data to the drive after the write request, and the write-through method has a property of a longer response time than that of the write-back method.

Meanwhile, the write-back method needs data protection in preparation for occurrence of a failure in the cache or a portion (e.g., a storage controller) containing the cache. For the data protection, there is a method of reserving redundancy of the write data by, e.g., providing a storage system with a redundant configuration with a plurality of controllers and by copying the write data received by a given one of the controllers to the cache of another of the controllers.

PTL 1 discloses a method of operating in the write-back method in a state where data protection in a cache can be performed and switching to a journal method when the data in the cache cannot be protected any longer.

Specifically, a storage controller in PTL 1 recognizes a status of another controller in a system, and operates in the write-back method when the other controller is normal. Meanwhile, when the other controller is in an abnormal status due to a failure or the like, the storage controller mentioned above generates a log related to update of a content of a memory at the time of reading/writing described above, and writes the log in a storage device. This can reduce the number of accesses to a drive required before a response to a host, compared to that in a case of using the write-through method for the drive belonging to the RAID configuration and can thereby increase response performance, and therefore it is possible to implement a storage system and a data protection method each having both high performance and high reliability.

### PATENT LITERATURE

[PTL 1] Japanese Patent Application Laid-open No. 2024-124097

### SUMMARY OF THE INVENTION

In the conventional method described above, in the event of a failure in the storage controller, during a period until data protected according to the write-back method before the occurrence of the failure is written to a user data drive, a degree of redundancy of the data temporarily deteriorates. For example, when another storage controller also fails during this period, the data protected according to the write-back method is lost. In other words, in the conventional method, when the storage controller fails while protecting the data using the log, the data is lost. In the embodiment using the conventional method, the data is lost when the one storage controller fails, and therefore this case of data loss is limited to a case where the failures occur at two or more locations.

It is to be noted herein that the storage system involves maintenance work in which the storage controller is stopped for replacement of the storage controller per se or parts inside the storage controller for the sake of failure deterrence. Even during a period of the maintenance work, the storage system continues to operate, and therefore operates the other storage controller to receive the write request from the host. At this time, when the conventional method is applied for data protection in the storage controller in operation, the storage controller fails, i.e., data is lost due to the failure at one of the locations. Thus, in the conventional method, no consideration is given to a situation in which cached data cannot be protected between the storage controllers due to a springboard for detriment other than the failure.

To solve the problem described above, a storage system according to the present invention is a storage system including: a nonvolatile storage device; and a plurality of storage controllers that control reading and writing to the storage device, each of the plurality of storage controllers including a processor and a memory, the storage controller including a first memory protection method, which is a memory duplication method that duplicates data in the memory into the memory of the corresponding storage controller, and a second memory protection method, which is a log backup method that generates a log related to update of the data in the memory and writes the log into the storage device, the storage controller storing in the memory a write request from a host to the storage device as cached data, the storage system starting, when receiving a maintenance work instruction that requires the first storage controller to be shut down, an operation of protecting the cached data according to the second memory protection method, while the second storage controller protects the cached data according to the first memory protection method, the storage system ending, when a status is established in which the cached data is protected according to the second memory protection method, the protection of the cached data according to the first memory protection method and shutting down the first storage controller.

According to the present invention, it is possible to perform data protection of cached data even during maintenance of the storage controller.

### BRIEF DESCRIPTION OF THE DRAWINGS

FIG. 1 is a configuration diagram of a storage system in a first embodiment;

FIG. 2 is a diagram illustrating a status transition of the storage system;

FIG. 3 is a diagram illustrating an outline of a write operation in a both controller in-operation status in the first embodiment;

FIG. 4 is a diagram illustrating the outline of the write operation in a base image abuilding status in the first embodiment;

FIG. 5 is a diagram illustrating the outline of the write operation in a one controller under-maintenance status in the first embodiment;

FIG. 6 illustrates a base image management table;

FIG. 7 illustrates a base image backup progress management table;

FIG. 8 illustrates a log management table;

FIG. 9 illustrates a log data structure;

FIG. 10 illustrates a storage status management table;

FIG. 11 is a flow chart of controller maintenance start processing;

FIG. 12 is a flow chart of controller maintenance end processing;

FIG. 13 is a flow chart of metadata update processing;

FIG. 14 is a flow chart of write data update processing;

FIG. 15 is a flow chart of log production processing;

FIG. 16 is a flow chart of log backup processing;

FIG. 17 is a flow chart of base image backup processing;

FIG. 18 is a flow chart of log recovery processing;

FIG. 19 is a structural view of the storage system in a second embodiment; and

FIG. 20 is a diagram illustrating the outline of the write operation in a one controller under-maintenance status in the second embodiment.

### DESCRIPTION OF THE PREFERRED EMBODIMENTS

Referring to the drawings, the following will describe embodiments of the present invention. However, the present invention is not to be construed to be limited to details of the description of the embodiments shown below. A person skilled in the art will easily understand that a specific configuration of the present invention can be changed within a scope not departing from the spirit or gist of the present invention.

In this specification or the like, terms such as “first”, “second”, and “third” are used to distinguish components from each other, and are not necessarily intended to limit the number or order of the components.

In a configuration of the invention described below, the same or similar configurations or functions are given the same reference signs, and a repeated description thereof is omitted.

Additionally, in the following description, it may be possible that, when components of the same type are not to be distinguished from each other, common signs (or reference signs) in reference signs are used while, when the components of the same type are to be distinguished from each other, the reference signs (or IDs of the components) are used.

A program is executed by a processor (e.g., a CPU (Central Processing Unit)) included in a storage controller (hereinafter referred to simply as the controller) in a storage device to perform determined processing, while appropriately using storage resources (e.g., a memory) and/or a communication interface device (e.g., a host I/F), and therefore a subject of the processing may be the storage device or processor. In addition, the storage controller may also include a hardware circuit that performs part or all of the processing. A computer program may also be installed from a program source. The program source may be, e.g., a program distribution server or a computer readable storage medium.

### First Embodiment

A description will be given of an operation when the storage system receives a maintenance operation that requires the controller to be shut down from a user. In the present embodiment, as a location where a log and a base image are be backed up, a region in a user drive is used.

In the present embodiment, the user drive serving as a location where write data is to be finally written is used also as the location where the log and the base image are to be backed up in a write-back method, and therefore an advantage of not requiring additional hardware in implementing the present invention is offered.

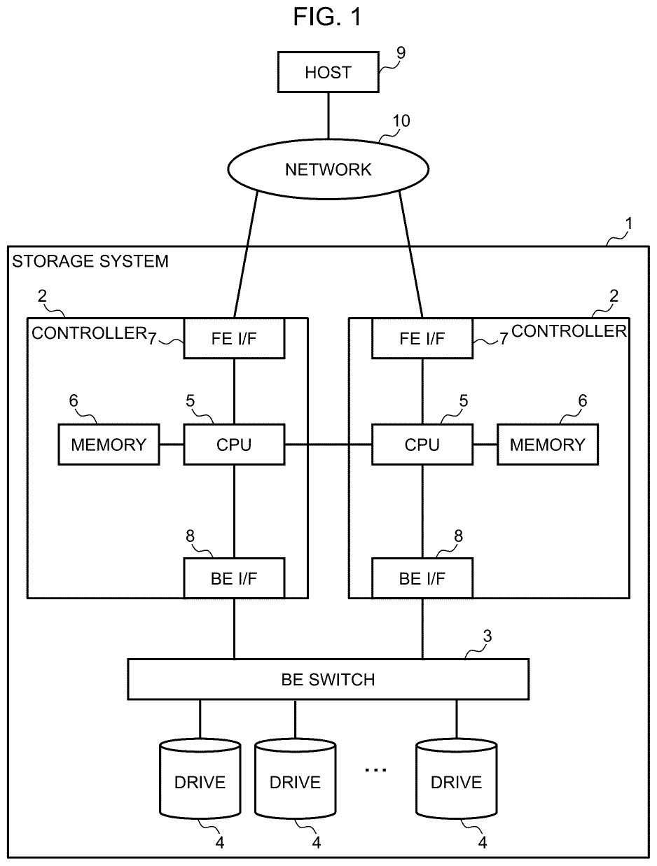

FIG. 1 is a diagram illustrating an example of a configuration of a storage system in the present embodiment. A storage system 1 in the present embodiment includes a plurality of storage controllers (hereinafter referred to simply as the controllers) 2, a back-end switch (hereinafter referred to as the BE switch) 3, and drives 4 each serving as a storage device. Each of the controllers 2 includes a CPU 5, a memory 6, a front-end interface (FE I/F) 7, and a back-end interface (BE I/F) 8. The drive 4 is, e.g., an SSD (Solid State Drive) using a flash memory as a storage medium, an HDD (Hard Disk Drive) using a magnetic disk as a storage medium, or the like. The FE I/F 7 is, e.g., a Fibre Channel HBA (Host Bus Adapter) or a NIC (Network Interface Controller). The BE I/F 8 is, e.g., a SAS HBA or a PCI Express (hereinafter referred to as the PCIe) adapter or NIC. The BE switch 3 couples each of the controllers 2 to the drive 4. In addition, the respective CPUs 5 of the plurality of controllers 2 are coupled together via an interconnect such as, e.g., PCIe. Note that the CPU 5 and the CPU 5 may also be coupled together via, e.g., a PCIe switch. The storage system 1 provides a host 9 with a data reading/writing function. Accordingly, the storage system 1 and the host 9 are coupled together via a network (SAN) 10 such as, e.g., the Fibre Channel or Ethernet. Note that the network 10 may also include a switch or the like. Alternatively, a plurality of the hosts 9 may also be coupled to the network 10.

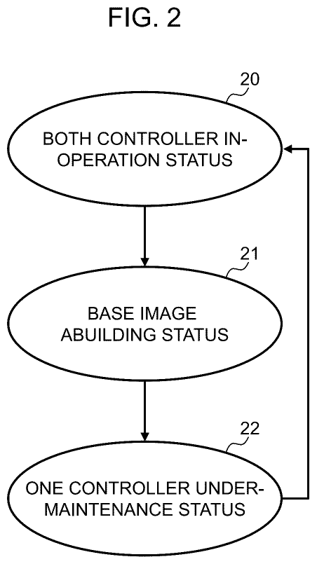

FIG. 2 is a diagram illustrating a status transition of the storage system 1. In a steady state, the storage system 1 is in a both controller in-operation status 20 so as to be able to provide the data reading/writing function to the host 9 even in the event of a failure in any of the components thereof. When the user gives the storage system 1 an instruction to perform the maintenance operation that requires the controller 2 to be stopped herein, the storage system 1 transitions to a base image abuilding status 21 to start base image backup processing S60. Next, when ending building of the base image in the drive 4 by the base image backup processing S60, the storage system 1 transitions to a one controller under-maintenance status 22 to stop the controller 2 to be maintained. In this status, the user performs the maintenance operation on the controller 2 in a shutdown state. Examples of the maintenance operation include physical replacement of the memory 6 and addition or removal of hardware attached to the controller 2. When the user notifies the storage system 1 of completion of maintenance, the storage system 1 activates the stopped controller 2 mentioned above and writes a content of the memory 6 of another controller 2 to the memory 6 of the activated controller 2 mentioned above and, when ending duplication of the data in the memory 6 of each of the controllers 2, the storage system 1 transitions to the both controller in-operation status 20. The foregoing is a flow of the maintenance operation in the present embodiment. Hereinafter, an outline of the write operation in each of the statuses will be described.

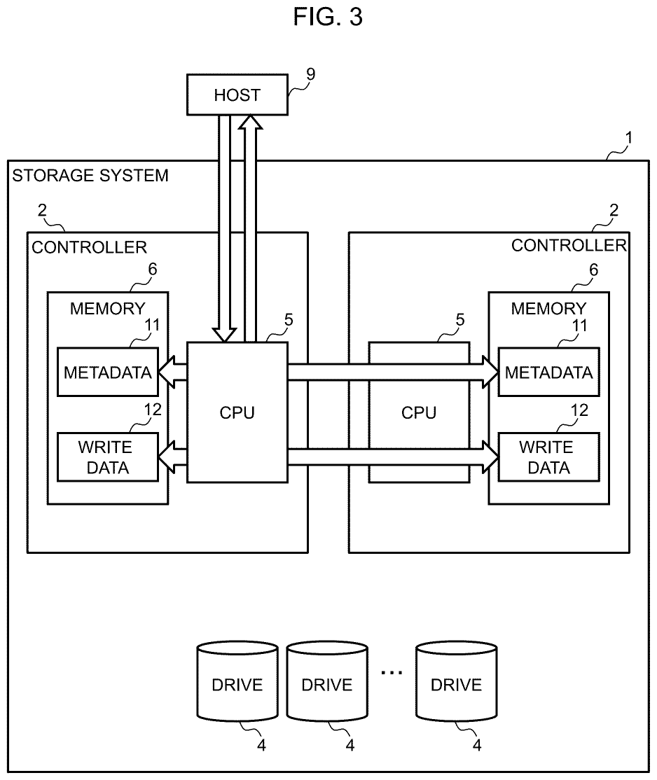

FIG. 3 is a diagram illustrating the outline of the write operation in the both controller in-operation status 20. The CPU 5 receives a write request from the host 9 to receive write data 12 from the host 9, and writes the write data 12 into the memory 6 of the host controller 2 and into the memory 6 of the other controller 2. In addition, the CPU 5 updates metadata 11 in the memory 6. The metadata 11 is information on the status transition of the storage system 1 in response to the write request. Examples thereof include such attribute information of the write data as a final update date of the write data 12 and inner information of the storage system 1 such as information on a location in the drive 4 determined by the storage system 1 to be a location where the write data 12 is to be stored. Then, the CPU 5 returns a write completion response to the host 9. In the addition, the CPU 5 writes the write data 12 in the memory 6 to the drive 4 with predetermined timing (de-stage), though illustration thereof is omitted. At this time, in preparation for a failure of the drive 4, the storage system 1 has a data protection mechanism using the plurality of drives 4, and reads and writes data from and to the drives 4 according to the mechanism. For example, when RAID 5 in a RAID (Redundant Array of Independent (or Inexpensive) Disks) group including the plurality of drives 4 is to be configured, the CPU 5 reads pre-update data of the write data 12 and the parity data from the drive 4, calculates the post-update parity data from these data sets, and writes the write data 12 and the post-update parity data to the individual drives 4. In this write operation, by duplicating the write data 12 and the metadata 11 in the memory 6 between the controllers 2, preparation is made for a failure of the controller 2.

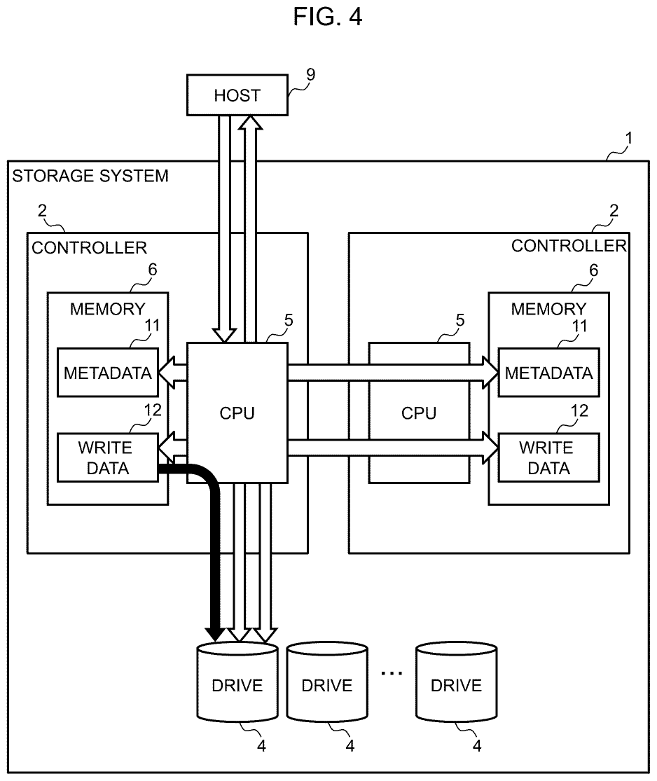

FIG. 4 is a diagram illustrating the outline of the write operation in the base image abuilding status 21. When receiving the write request from the host 9, the CPU 5 writes details of update of the metadata 11 and details of update of the write data 12 as a log to the drive 4 (log backup) in addition to writing the data to the both memories 6 described above, and gives the write completion response to the host 9. A purpose of this log is to hold the content of the memory 6 also in the drive 4 in preparation for a failure of the controller 2, and the content of the memory 6 needs only to be written to one location in the drive 4. However, it may also be possible to apply the data protection mechanism for preparing also for a failure of the drive 4. For example, the RAID described previously can be listed. In this case also, the log is temporary data which is valid until the base image backup described later is completed and, since an amount of the held data is smaller than that of the whole write data 12, it is possible to reduce a write response time by adopting a method inferior in capacity efficiency, but having a high processing efficiency, e.g., RAID 1.

In this write operation, duplication is performed using the log in the memory 6 and the drive 4 of the host controller 2 so as to allow the data protection of the write data 12 mentioned above to be performed even at a time when the controller 2 is shut down. In addition, the CPU 5 also performs the base image backup processing S60 to write the metadata 11 and the write data 12 each stored in the memory 6 of the host controller 2 to the drive 4. The base image backup processing S60 is performed independently of processing based on the write request from the host 9. By the base image backup processing S60, the write data 12 and the metadata 11 written in the both memories 6 mentioned above in the both controller in-operation status 20 is written to the drive 4.

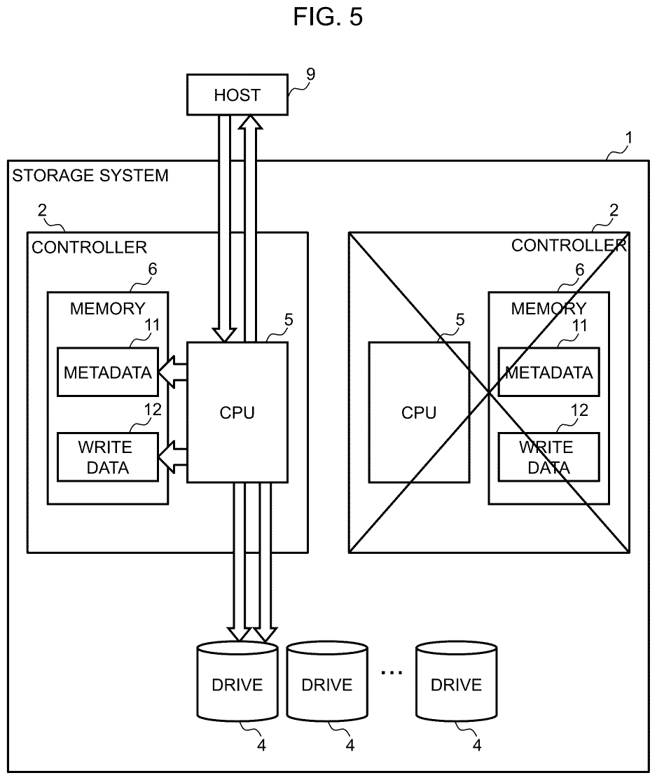

FIG. 5 is a diagram illustrating an outline of a write operation in the one controller under-maintenance status 22. The CPU 5 of the controller 2 not to be maintained receives the write request from the host 9 and writes the write data 12 into the memory 6 in the host controller. The CPU 5 also writes the log of the write data 12 and metadata 11 described above to the drive 4. Then, the CPU 5 returns the write completion response to the host 9. In addition, the CPU 5 writes the write data written in the memory to the drive with predetermined timing (de-stage), though illustration thereof is omitted. Furthermore, the CPU 5 also performs the base image backup processing S60. This is because the log includes information on the location in the memory 6 and an order of writing in addition to the write data 12 and the metadata 11, and usage of the drive 4 increases. Therefore, by periodically re-building the base image by the base image backup processing S60 and discarding the log before the re-building, a vacant region in the drive 4 is retrieved.

In the storage system 1 in the present embodiment, the content of the memory 6 is made redundant in the drive 4 in the base image abuilding status 21 to be prepared for a case where the controller 2 fails in the one controller under-maintenance status 22. In other words, in a case where the controller 2 fails (single-point failure), the storage system 1 is temporarily stopped (system crash) but, by replacing the controller 2 with normal hardware and then restoring the write data 12 and the metadata 11 in the memory 6 by using the base image and the log in the drive 4, it is possible to prevent a data loss.

To avoid confusion in the following description, a difference between the de-stage and writing of the log (referred to as log backup) is clarified herein. The de-stage refers to writing of the write data 12 in the memory 6 to a final storage region in the drive 4 serving as a final storage medium. In the drive 4, by a storage function provided by the storage system 1 (mainly the controller 2), the data protection, capacity efficiency, I/O performance, and the like are enhanced, and the write data 12 is stored. For example, in the data protection, the data is protected according to a method such as RAID 5 and, in that case, the parity data is generated by de-stage processing, and the parity data is also written to the drive 4. The write data 12 for which the de-stage is completed is in a state (clean) where the data in the memory 6 coincides with the data in the drive 4, and therefore it is acceptable that the write data 12 is lost from the memory 6.

Meanwhile, the log backup refers to temporarily writing details of the update of the write data 12 and the metadata 11 in the memory 6 to a nonvolatile storage medium (drive 4) in preparation for an unexpected failure of the controller 2. As described previously, once the de-stage of the write data 12 is completed, there is no problem even if the write data 12 written as the log to the drive 4 is lost from the memory 6, and therefore the log can be deleted from the drive 4 at a time when the de-stage is completed.

Note that each of the base image and the log may be of one type, but it may also be possible to divide the region in the memory 6 and provide a plurality of types of the base images and the logs. When a frequency and an amount of writing of the write data 12 and the metadata 11 differ from one of the regions in the memory 6 to another, by providing these as the different types of base images and logs, it is possible to preferentially re-build the base image corresponding to the region in the memory 6 where the frequency and amount of the writing are high and large and efficiently discard a large number of the logs related to the region in the memory 6. In the present embodiment, a description will be given of an example in which there are the plurality of types of base images and logs.

Hereinbelow, an implementation example of the present embodiment will be described using a management table and a flow chart.

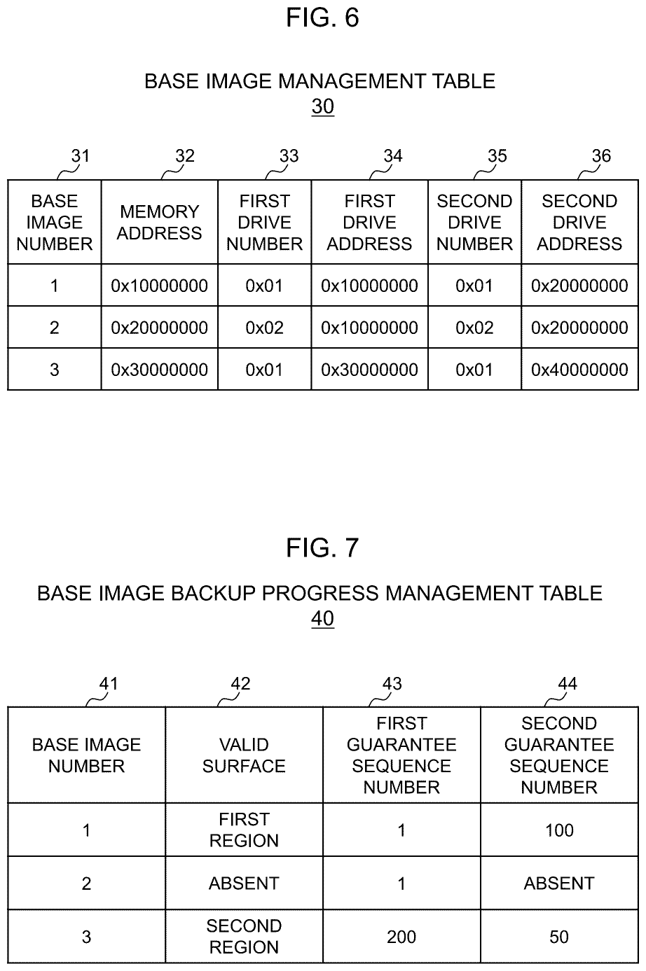

FIG. 6 illustrates an example of a configuration of a base image management table 30. The base image management table 30 associates the regions in the memory 6 with regions in the drive 4 where the base image is to be built. The base image backup processing S60 is started herein when the storage system 1 transitions to the base image abuilding status 21, and continuously operates to re-build the base image even when the storage system 1 subsequently transitions to the one controller under-maintenance status 22. At this time, it is necessary to build a new base image without destroying the built base image. In the present embodiment, as a means therefor, a method of providing two base image regions in the drive 4 and alternately using the two base image regions is assumed and will be described. The base image management table 30 includes a base image number 31, a memory address 32, a first drive number 33, a first drive address 34, a second drive number 35, and a second drive address 36.

FIG. 7 illustrates an example of a configuration of a base image backup progress management table 40. The base image backup progress management table 40 manages which one of the base image regions mentioned above is to be used. In addition, the base image backup progress management table 40 also manages information specifying the log that can be discarded at the completion of the building of the base image. The base image backup progress management table 40 includes a base image number 41, a valid surface 42, a first guarantee sequence number 43, and a second guarantee sequence number 44.

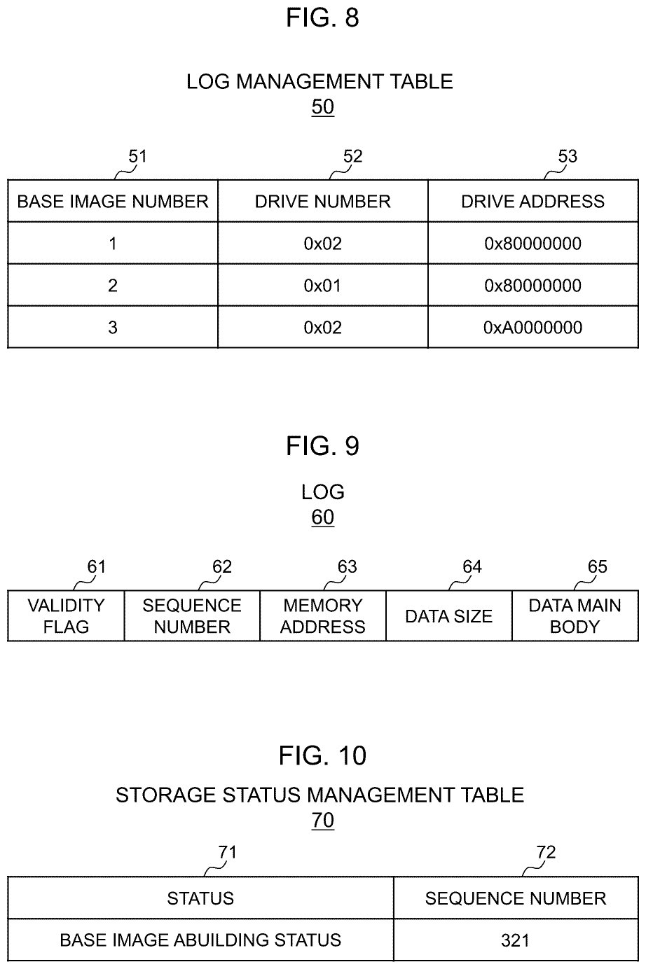

FIG. 8 illustrates an example of a configuration of the log management table 50. The log management table 50 manages the regions in the drive 4 where the logs are to be backed up. The log management table 50 includes a base image number 51, a drive number 52, and a drive address 53.

FIG. 9 illustrates an example of a data structure of a log 60. The log 60 is data to be generated at the time of updating the write data 12 and the metadata 11 in the memory 6, and has the data structure in which location information and a data main body, which are required for recovery of the memory 6, are integrated when the controller 2 is to be activated after a failure of the controller 2. The log 60 includes a validity flag 61, a sequence number 62, a memory address 63, a data size 64, and a data main body 65.

FIG. 10 illustrates an example of a configuration of the storage status management table 70. The storage status management table 70 includes a status 71 and a sequence number 72.

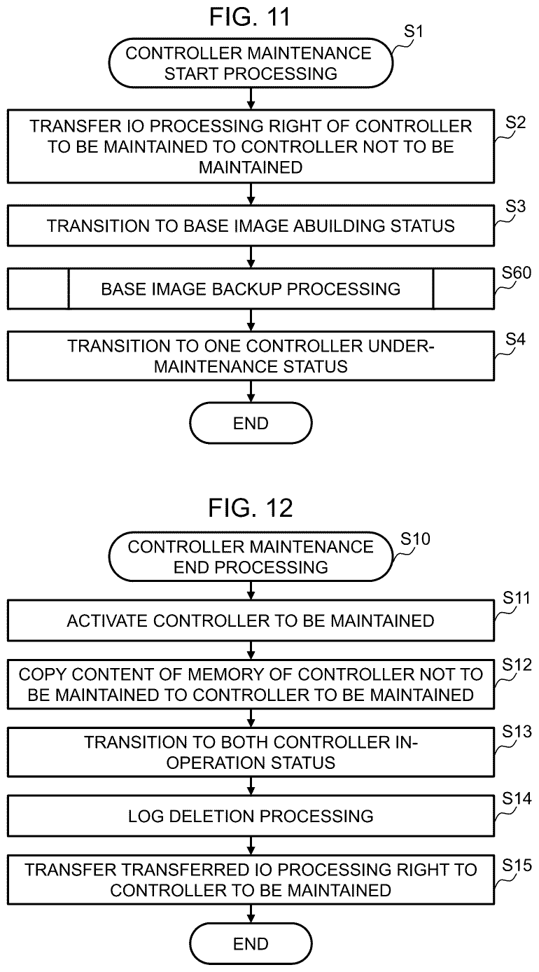

FIG. 11 is a flow chart of maintenance start processing by the controller 2 in the storage system 1 in the present embodiment, which is executed by the CPU 5. When the user gives an instruction to perform the maintenance operation that requires the controller 2 to be stopped to the storage system 1, controller maintenance start processing S1 is executed.

The CPU 5 transfers an IO processing right of the controller 2 to be maintained to the controller 2 not to be maintained (S2). Note that what is to be transferred is not limited to the IO processing right as long as a right or resources required for the data reading/writing function provided by the storage system 1 to the host 9 are transferred. Alternatively, as long as the controller 2 to be maintained is in a status where the function is not provided to the host 9, e.g., a so-called standby state, Step S2 need not be performed.

Next, the CPU 5 sets a value indicating the base image abuilding status to the status 71 of the storage status management table 70 to thereby cause the storage system 1 to transition to the base image abuilding status 21 (S3).

The CPU 5 executes the base image backup processing (S60). Since a size of the memory 6 is large compared to a speed of writing to the drive 4, the base image backup processing S60 may take time. Accordingly, it may also be possible that, after giving an instruction to write the base image to the drive 4, the CPU 5 temporarily performs another processing such as metadata update processing (S20) or write data update processing (S30) described later, and then resumes the execution of the present step. Alternatively, when the CPU 5 has a plurality of processing operation modules (cores), the present step and another processing may also be executed separately by the different cores in parallel.

Then, the CPU 5 transmits a stop request to the controller 2 to be maintained, and the CPU 5 in the controller 2 to be maintained that has received the stop request gives a stop instruction to components in the controller 2 such as the memory 6, the FE I/F 7, and the BE I/F 8 as necessary. Thereafter, the CPU 5 in the controller 2 to be maintained is stopped to bring the controller 2 to be maintained into a stopped status. After the controller 2 to be maintained was brought into the stopped status, the CPU 5 in the controller 2 not to be maintained mentioned above sets a value indicating the one controller under-maintenance status to the status 71 of the storage status management table 70 to thereby cause the storage system 1 to transition to the one controller under-maintenance status 22 (S4). Note that the CPU 5 mentioned above may determine that the controller 2 to be maintained was brought into the stopped status by periodical life-and-death monitoring such as, e.g., a heartbeat or may also determine that the controller 2 to be maintained was brought into the stopped status on the basis of a notification that the CPU 5 in the controller 2 to be maintained is brought into the stopped status, which is transmitted to the CPU 5 mentioned above.

Thus, the storage system 1 in the present embodiment can stop the controller 2, while maintaining the data protection of the write data 12 and the metadata 11.

FIG. 12 is a flow chart of maintenance end processing by the controller 2 in the storage system 1 in the present embodiment, which is executed by the CPU 5 of the controller 2 not to be maintained. When the user gives an instruction to recover the stopped controller 2 mentioned above to the storage system 1, controller maintenance end processing S10 is executed by the CPU 5 of the controller 2 not to be maintained.

The CPU 5 gives an instruction to activate the stopped controller 2 mentioned above (S11). This method may be a method of, e.g., starting power supply to the controller 2 mentioned above or may also be a method in which a power source operation unit is mounted in the controller 2 mentioned above, the power supply to the power source operation unit mentioned above is continued even in the one controller under-maintenance status, and the power source operation unit mentioned above receives the activation instruction mentioned above to start power supply to each of portions in the controller 2 mentioned above.

Then, the CPU 5 copies the content of the memory 6 in the host controller 2 to the memory 6 in the activated controller 2 mentioned above (S12).

Subsequently, the CPU 5 causes the storage system 1 to transition to the both controller in-operation status 20 (S13).

Then, the CPU 5 deletes the base image and the log that are no longer needed because the protection of the both memories 6 was validated (S14).

In addition, the CPU 5 transfers the IO processing right transferred in Step S2 described above to the activated controller 2 mentioned above (S15).

Note that the processing order of Step S14 and Step S15 may also be switched.

Thus, the storage system 1 in the present embodiment can activate the controller 2, while maintaining the data protection of the write data 12 and the metadata 11.

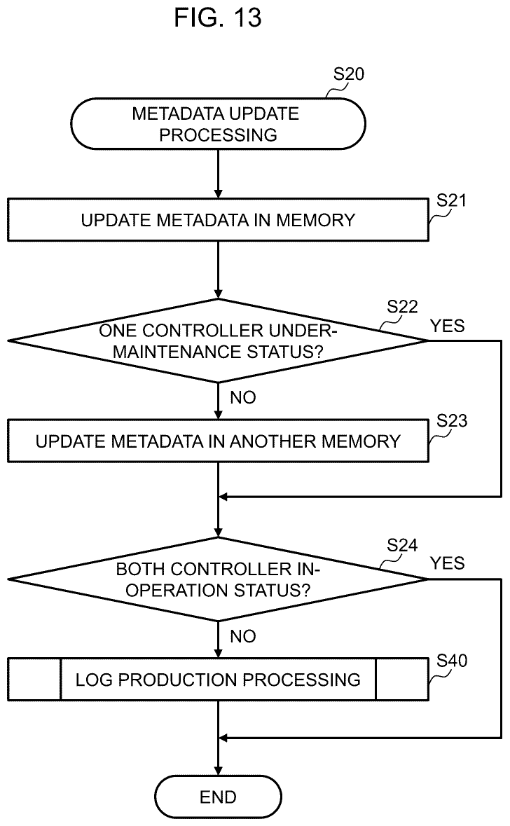

FIG. 13 is a flow chart of the metadata update processing S20 in the storage system 1 in the present embodiment, which is executed by the CPU 5. The metadata update processing S20 is executed when the CPU 5 updates the status of the storage system 1. This may be triggered by, e.g., an instruction from outside the storage system 1, such as that to update a final update date of the write data 12 when the write data 12 is received from the host 9, or by processing inside the storage system 1, such as recording of a check time and a check result when the storage system 1 periodically checks the operation of the components.

The CPU 5 rewrites details of the metadata 11 in the memory 6 (S21).

Next, the CPU 5 determines whether or not the storage system 1 is in the one controller under-maintenance status 22 (S22). In a case of YES, the processing advances to Step S24 while, in a case of NO, the processing advances to Step S23.

The CPU 5 updates the metadata 11 in the memory 6 of the other controller 2 (S23). Depending on a method of coupling the CPUs 5 together, it may be possible that the CPU 5 mentioned above performs direct writing to the region in the memory 6 mentioned above, or may also be possible to use a method in which the CPU 5 mentioned above transmits an update request to the CPU 5 of the other controller 2 and the CPU 5 of the other controller 2 performs writing to the region in the memory 6 mentioned above.

Subsequently, the CPU 5 determines whether or not the storage system 1 is in the both controller in-operation status 20 (S24). When the storage system 1 is in the both controller in-operation status 20, the metadata update processing S20 is ended and, otherwise, processing in Step S40 is performed. The processing in Step S40 will be described later.

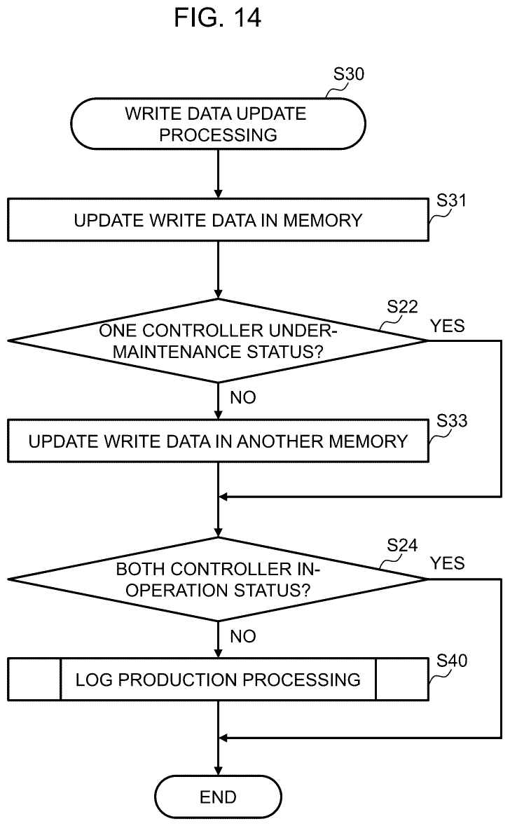

FIG. 14 is a flow chart of the write data update processing S30 in the storage system 1 in the present embodiment, which is executed by the CPU 5. The CPU 5 executes the write data update processing S30 when receiving the write data 12 from the host 9.

The CPU 5 rewrites details of the write data 12 in the memory 6 (S21).

Next, the CPU 5 determines whether or not the storage system 1 is in the one controller under-maintenance status 22 (S22). In the case of YES, the processing advances to Step S24 while, in the case of NO, the processing advances to Step S33.

The CPU 5 updates the write data 12 in the memory 6 of the other controller 2 (S33). Depending on the method of coupling the CPUs 5 together, in the same manner as in Step S23 described above, the CPU 5 of either of the controllers 2 may perform writing to the memory 6 mentioned above.

Subsequently, the CPU 5 determines whether or not the storage system 1 is in the both controller in-operation status 20 (S24). When the storage system 1 is in the both controller in-operation status 20, the write data update processing S30 is ended and, otherwise, the processing in Step S40 is performed. The processing in Step S40 will be described later.

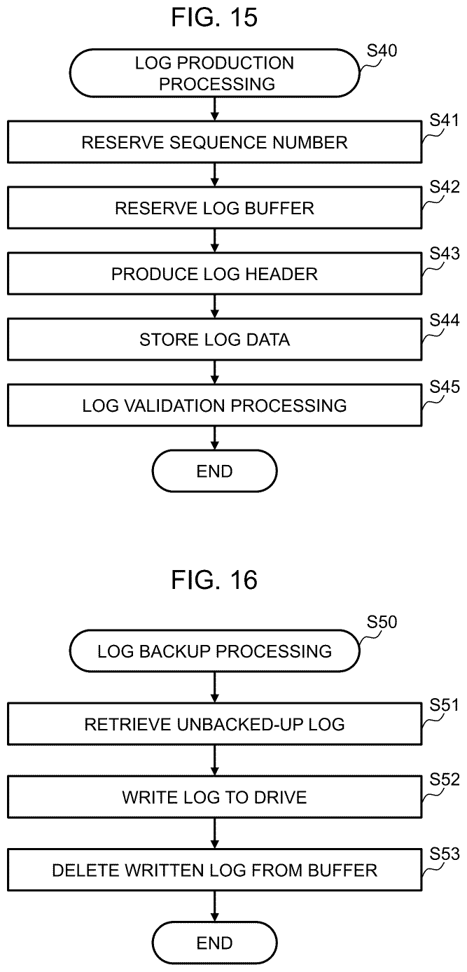

FIG. 15 is a flow chart of log backup processing S50 in the storage system 1 in the present embodiment, which is executed by the CPU 5.

First, the CPU 5 reserves a sequence number (S41). The sequence number indicates an order of production of the log and, every time a new log is produced, a value of the sequence number is increased by 1. Specifically, the CPU 5 acquires the sequence number 72 in the storage status management table 70, and sets a value one larger than the previous value to the sequence number 72.

Next, the CPU 5 reserves a log buffer as a place where the log 60 to be written to the drive 4 is to be produced (S42). The log buffer is a region in the memory 6.

Subsequently, the CPU 5 produces a log header (S43). Specifically, in the log buffer, the sequence number reserved in Step S41 described above is stored as the sequence number 62 in the log 60. As the memory address 63, an address in the memory 6 updated in Step S21 or Step S31 is stored. Then, as the data size 64, the size of the data updated in Step S21 or Step S31 is stored.

Then, the CPU 5 stores the data updated in Step S21 or Step S31 as the data main body 65 (S44).

Finally, the CPU 5 performs processing of validating the produced log (S45). This is executed by setting a value indicating validity to the validity flag 61 in the log 60 mentioned above.

FIG. 16 is a flow chart of the log backup processing S50 in the storage system 1 in the present embodiment.

The log backup processing S50 is processing of writing the logs accumulated in the log buffer to the drive 4, which is executed before the CPU 5 responds to the host 9.

The CPU 5 retrieves, from inside the log buffer mentioned above, the log 60 in which the valid value is set to the validity flag 61 (S51).

The CPU 5 writes the log 60 mentioned above to the drive 4 (S52). Specifically, the CPU 5 compares the memory address 32 of each of entries in the base image management table 30 to the memory address 63 in the log 60 mentioned above to specify the entry in the base image management table 30 to which the log 60 mentioned above belongs. Next, the CPU 5 specifies the entry in the log management table 50 that coincides with the base image number 31 of the entry. Then, the CPU 5 specifies, on the basis of the drive number 52 of the entry, the drive 4 to which writing is to be performed and gives, to the drive, an instruction to write the log 60 mentioned above to the drive address 53. Finally, the CPU 5 adds the drive address 53 of the entry by the size of the log 60 so as to allow a next write destination of the log 60 to be specified.

The CPU 5 deletes the log 60 mentioned above from the log buffer (S53). This may also be implemented by setting a value indicating invalidity to the validity flag 61 of the log 60.

Thus, the production of the log and the write operation to the drive 4 has been described. Especially in a case of the metadata 11, a size of the log 60 may be smaller than a data write unit of the drive 4. In this case, when the produced log is written every time to the drive 4, an efficiency of writing to the drive 4 is low. Accordingly, the present embodiment has described a method of providing the log buffer, accumulating the logs 60, and then writing the logs 60 to the drive 4. However, a method of writing a log to the drive 4 every time the log is produced may also be used.

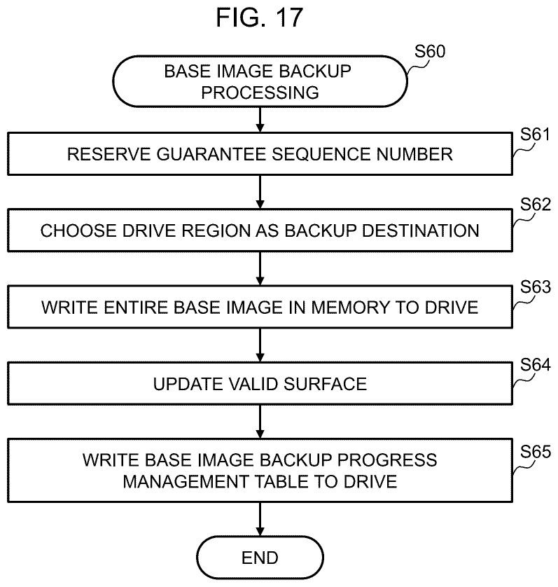

FIG. 17 is a flow chart of the base image backup processing S60 in the storage system 1 in the present embodiment.

As described previously, the base image backup processing S60 is processing of writing the entire region of the memory 6 to be protected to the drive 4 and, in the present embodiment, before the controller 2 is stopped, the base image backup processing S60 is used to protect the metadata 11 and the write data 12 protected between the memories 6 and discard the log continuously stored in the drive 4. When the status 71 of the storage status management table 70 has a value indicating the base image abuilding status 21, all the base image numbers are targets of base image backup. Meanwhile, when the status 71 of the storage status management table 70 has a value indicating the one controller under-maintenance status 22, only the base image for which the number of the valid logs in the drive 4 exceeds a threshold is a backup target.

First, the CPU 5 refers to the sequence number 72 in the storage status management table 70 and stores a latest sequence number at the current time (S61).

Then, the CPU 5 refers to the valid surface 42 to determine, for the entry corresponding to the base image as the backup target in the base image backup progress management table 40, a drive region to be used for building and stores the latest sequence number mentioned above in the first guarantee sequence number 43 or the second guarantee sequence number 44 according to the determined region. In addition, the CPU 5 sets the initial value to the first drive address 34 or the second drive address 36 in the base image management table 30. Specifically, as long as the value of the valid surface 42 is a value indicating absence of a valid surface or a value indicating a second region, the CPU 5 determines to build the base image by using a first region, and sets the latest sequence number mentioned above to the first guarantee sequence number 43. To the first drive address 34, the CPU 5 sets a leading address for base image storage statically determined in advance. Meanwhile, when the value of the valid surface 42 is a value indicating the first region, the CPU 5 determines to build the base image by using the second region, and sets the latest sequence number mentioned above to the second guarantee sequence number 44. To the second drive address 36, the leading address for base image storage statically determined in advance is set.

Subsequently, the CPU 5 writes the content of the memory 6 as the base image to the drive 4 (S63). Specifically, the CPU 5 specifies the entry in the base image management table 30 that coincides with the base image number of the backup target. According to the region to be used for the building described above, the CPU 5 chooses the first drive number 33 or the second drive number 35 of the specified entry to specify the drive 4 as a backup destination (S62). The CPU 5 chooses the first drive address 34 or the second drive address 36 of the similarly specified entry, and writes data in the memory 6 indicated by the memory address 32 of the specified entry to the specified drive 4 mentioned above. When the size of the base image is large, a request for writing to the drive 4 may be divided into a plurality of sections. In this case, it may also be possible that the first drive address 34 or the second drive address 36 is updated and used to calculate a write destination to be specified in response to each write request.

The CPU 5 sets a value of the region to be used for the building mentioned above to the valid surface 42 of the base image backup progress management table 40 (S64).

Finally, the CPU 5 writes the base image backup progress management table 40 to a fixed address in the drive 4 determined in advance (S65).

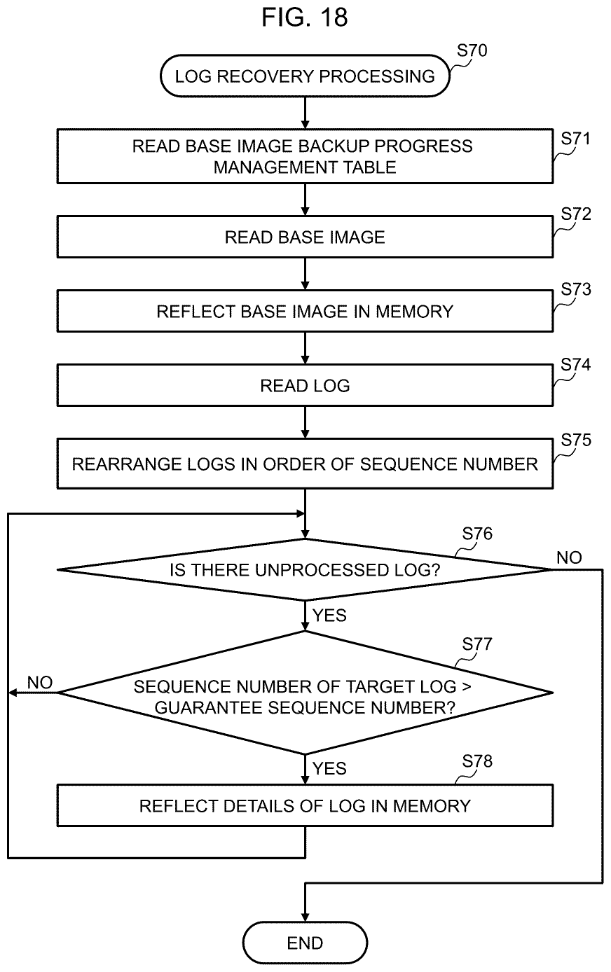

FIG. 18 is a flow chart of log recovery processing S70 in the storage system 1 in the present embodiment.

The present processing is executed in processing of activating the system after the system crash due to a failure of the controller 2 not to be maintained in the one controller under-maintenance status 22 and after maintenance work for the controller 2 or the like was performed. By the present processing, the write data 12 and the metadata 11 stored in the memory 6 before the system crash is recovered. The present processing is executed by the CPU 5 of the predetermined controller 2 in the storage system 1 before IO reception is resumed. The predetermined controller 2 is not the maintenance target, but the failed controller 2. The failed controller 2 is, e.g., replaced and, when the controller 2 after the replacement is activated, the log recovery processing S70 is performed.

First, the CPU 5 reads, from the fixed address mentioned above in the drive 4, the base image backup progress management table 40 (S71).

Next, the CPU 5 refers to the valid surface 42 in the base image backup progress management table 40 mentioned above, specifies the region of the finally built base image, and reads the base image out of the region in the drive 4 corresponding to the region of concern (S72).

Subsequently, the CPU 5 writes the read base image mentioned above to the memory 6 (S73).

Then, the CPU 5 reads the logs 60 from the drive 4 (S74), and sorts the logs 60 in ascending order of the sequence number (S75).

The CPU 5 sequentially refers to the sorted logs 60 mentioned above to determine whether or not there is the unprocessed log 60 (S76). In the case of YES, the processing advances to Step S77 while, in the case of NO, the log recovery processing S70 is ended.

The CPU 5 refers to the base image backup progress management table 40 mentioned above, stores, as the sequence number for which recovery is guaranteed by the base image, the first guarantee sequence number 43 when the valid surface 42 has a value indicating the first region or the second guarantee sequence number 44 when the valid surface 42 has a value indicating the second region, and compares the stored sequence number to the sequence number 62 of the unprocessed log 60 mentioned above (S77). When the sequence number 62 mentioned above is larger, the processing advances to S77 and, otherwise, the processing determines that the log 60 of concern was discarded, and advances to Step S76.

The CPU 5 copies, to a location in the memory 6 corresponding to the memory address 63, the data main body 65 of the log 60 mentioned above by a size of the data size 64 (S78).

By the foregoing processing, the content of the memory 6 is restored to information before the system crash mentioned above.

Thus, the first embodiment has been described. The present embodiment uses the method of writing the base image and the logs 60 to the drive 4 for storing the write data 12, and offers an advantage in that the effects of the present invention can be obtained without adding special hardware to the controllers 2.

### Second Embodiment

Next, the second embodiment will be described.

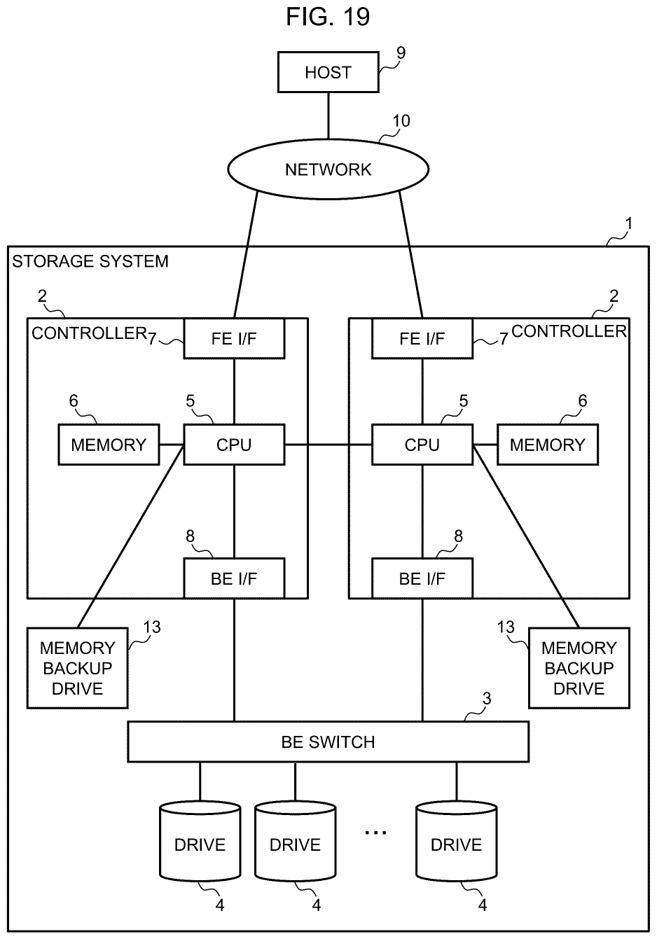

FIG. 19 is a diagram illustrating an example of a configuration of the storage system according to the present embodiment.

The storage system 1 in the present embodiment is different from the storage system 1 in the first embodiment in having a memory backup drive 13. The memory backup drive 13 is coupled to the CPU 5. The following will describe a difference from the first embodiment.

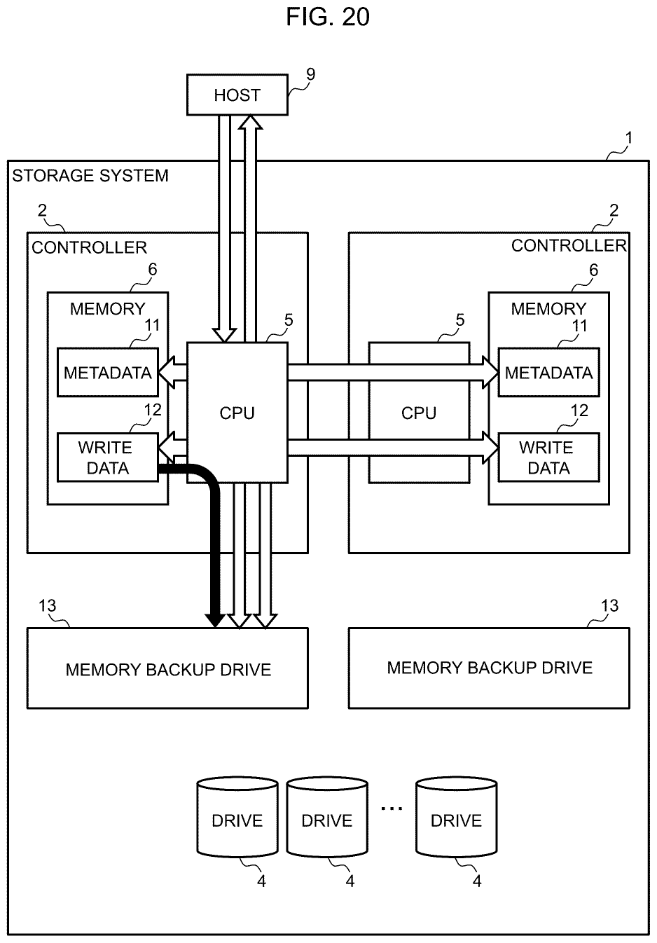

FIG. 20 is a diagram illustrating the outline of the write operation in the base image abuilding status 21 in the present embodiment. Unlike in the first embodiment, the CPU 5 in the present embodiment uses the memory backup drive 13 as a location to which the base image and the log 60 are to be written. In other words, in the present embodiment, to the first drive number 33 and the second drive number 35 in the base image management table 30 and to the drive number 52 in the log management table 50, values indicating the memory backup drive 13 are set.

The present embodiment is advantageous in that, by avoiding writing of the base image and the log 60 to the drive 4 to be used in the de-stage processing described above, an increase of a load of writing to the drive 4 is suppressed to prevent an adverse effect on performance of the de-stage processing. In addition, while data amounts of the base image and the log 60 are smaller compared to the entire write data, a host response cannot be returned to the host 9 until the writing of the log 60 is completed. In other words, a nonvolatile medium to which the base image and the log 60 are to be written preferably has a property of being able to perform high-speed data writing, even though a capacity thereof is small. In the present embodiment, it is possible to selectively use and mount a large-capacity nonvolatile medium with a low data write speed in the drive 4, while selectively using and mounting a small-capacity nonvolatile medium with a high data write speed in the memory backup drive 13. The nonvolatile medium with the low data write speed tends to have low bit cost, and therefore the selective use thereof also offers an advantage of suppressing cost of the storage system 1.

### Third Embodiment

Next, a third embodiment will be described.

The first embodiment and the second embodiment have been described on the assumption of the maintenance operation for one of the controllers 2 of the storage system 1. Examples of the maintenance operation include preventive replacement of aging parts and addition or removal of parts.

In the present embodiment, a description will be given of the maintenance operation for the both controllers 2. As an example of this maintenance operation, an operation of replacing the controller 2 of the storage system 1 currently in operation with the next-generation controller 2 when the next-generation storage system 1 is released and thereby updating the generation of the storage system 1 without stopping business operations can be listed. As another example thereof, an operation of temporarily stopping each of the controllers 2 and updating the program to be executed by the CPU 5 for version upgrade of the program can be listed.

The present embodiment can be implemented by switching the maintenance target controller and causing the status transition illustrated in FIG. 2 a plurality of times. Specifically, in the both controller in-operation status 20, one of the controllers 2 is determined to be the maintenance target and caused to transition therefrom to the base image abuilding status 21 and to the one controller under-maintenance status 22, whereby the controller 2 as the maintenance target mentioned above is maintained. This maintenance is, e.g., the replacement with the next-generation controller 2 or the update of the program to be executed by the CPU 5. Note that a method of determining the controller 2 as the maintenance target may be specification thereof by the user, determination of the controller 2 having the lower serial number if the controllers 2 have serial numbers, or selection of the controller 2 at the leftmost or uppermost physical mounting position.

When the maintenance work described above is ended, the storage system 1 transitions to the both controller in-operation status 20 to determine the controller 2 different from the controller 2 determined to the maintenance target described above to be a maintenance target and cause transition of the controller 2 determined to be the maintenance target to the base image abuilding status 21 mentioned above, transition thereof to the one controller under-maintenance status 22, the maintenance work thereon, and transition of the controller 2 determined to be the maintenance target to the both controller in-operation status 20.

Thus, in the status transition in FIG. 2, the data protection can be maintained and therefore, by repeating these, the plurality of controllers 2 in the storage system 1 can sequentially be maintained. Note that the present embodiment has been described on the assumption that there are the two controllers 2 in the storage system 1, but a person skilled in the art would easily understand that, even in the storage system 1 including the three or more controllers 2, the same procedure is established.

As has been described above, the storage system disclosed in each of the embodiments is a storage system (1) including a nonvolatile storage device (4) and a plurality of storage controllers (2) that control reading and writing to the storage device, each of the plurality of storage controllers including a processor (5) and a memory (6), the storage controller including a first memory protection method, which is a memory duplication method that duplicates data in the memory into the memory of the corresponding storage controller, and a second memory protection method, which is a log backup method that generates a log related to update of the data in the memory and writes the log into the storage device, the storage controller storing a write request from a host to the storage device as cached data in the memory, protecting the cached data according to the first memory protection method or the second memory protection method, and then returning a write completion response to the host, the storage system starting, when receiving a maintenance work instruction that requires the first storage controller to be shut down, an operation of protecting the cached data according to the second memory protection method, while the second storage controller protects the cached data according to the first memory protection method, the storage system ending, when a status is established in which the cached data is protected according to the second memory protection method, the protection of the cached data according to the first memory protection method and shutting down the first storage controller.

With the configuration and operation, the storage system can perform data protection of the cached data even during the maintenance of the storage controller.

In addition, the storage system activates the first storage controller when receiving an instruction to complete maintenance work for the first storage controller, the storage system duplicates the cached data in the memory of the second storage controller to the first storage controller to protect the cached data according to the first memory protection method, and the storage system discards the log in the storage device.

With the configuration and operation, when the maintenance is normally ended, the data in the memory is duplicated to allow the cached data to have redundancy

In addition, in the storage system, when the second storage controller fails while the first storage controller is shut down, the second storage controller that has recovered from the failure reads the log generated according to the second memory protection method from the storage device and restores the cached data.

With the configuration and operation, when a failure occurs during the maintenance, it is possible to restore the cached data.

In addition, by way of example, the storage system further includes, as the storage device, a user drive serving as a final write destination of write data, which is indicated by the write request, and a log drive that stores the log, and the storage controller writes the log generated according to the second memory protection method to the log drive.

With the configuration and operation, it is possible to use a small-capacity and high-speed storage device as the log drive, use a large-capacity and low-speed storage device as the user drive, and suppress cost.

In addition, when receiving the write request, the storage system determines whether or not either of the first storage controller and the second storage controller is under maintenance and determines whether or not both of the first storage controller and the second storage controller are in operation, protects the cached data according to the first memory protection method unless either of the first storage controller and the second controller is under maintenance, and protects the cached data according to the second memory protection method unless either of the first storage controller and the second storage controller is in operation.

With the configuration and operation, when a write request is processed, appropriate data protection can be performed according to a status of the storage controller.

In addition, when the storage system receives a maintenance operation instruction that requires the plurality of storage controllers to be shut down, the second storage controller protects the cached data according to the second memory protection method, the storage system shuts down the first storage controller, the storage system activates the first storage controller when receiving an instruction to complete maintenance work for the first storage controller, the storage system duplicates, to the first storage controller, the cached data in the memory of the second storage controller to protect the cached data according to the first memory protection method, the storage system discards the log in the storage device, and the storage system switches the first storage controller and the second storage controller to each other to execute the protection of the cached data from starting of the second memory protection method to the discarding of the log.

With the configuration and operation, it is possible to sequentially perform maintenance work on the plurality of storage controllers.

In addition, after protecting the cached data according to the first memory protection method or the second memory protection method, the storage controller returns a write completion response to the host and de-stages the cached data to the storage device after the write completion response.

In a conventional method, data protected according to the write-back method is written to a user data drive, and data in a cache is deleted, and consequently a performance improving effect due to a cache hit cannot be expected. By contrast, with the configuration and operation described above, the data protected according to the write-back method before the maintenance operation is subjected to the data protection by the base image backup processing to be able to be used as the cached data even during the shutdown of the storage controller, and a performance improvement due to the cache hit can be expected.

In addition, when the storage system receives the maintenance work instruction, the second storage controller writes the data in the memory of the second storage controller to the storage device.

With the configuration and operation, at a time when the maintenance work is started, it is possible to protect the entire data to be stored in the memory, including the cached data.

Thus, using the embodiments, an operation of the storage system in the present invention has been described. However, the present invention is not limited to the embodiments described above, and includes various modifications. The embodiments have been described above in detail for easy understanding of the present invention, and are not necessarily limited to an embodiment having all of the configurations described. In addition, it is not only possible to delete such configurations, but also to replace or add configurations. For example, although the application of the present invention to the maintenance work for the controllers has been described, it may also be possible to apply the present invention to a case where one of the controllers is suspended in order to reduce power consumption.

What is claimed is:

1. A storage system comprising:
a nonvolatile storage device; and
a plurality of storage controllers that control reading and writing to the storage device,
each of the plurality of storage controllers including a processor and a memory,
the storage controller including a first memory protection method, which is a memory duplication method that duplicates data in the memory into the memory of the corresponding storage controller, and a second memory protection method, which is a log backup method that generates a log related to update of the data in the memory and writes the log into the storage device,
the storage controller storing in the memory a write request from a host to the storage device as cached data,
the storage system starting, when receiving a maintenance work instruction that requires the first storage controller to be shut down, an operation of protecting the cached data according to the second memory protection method, while the second storage controller protects the cached data according to the first memory protection method,
the storage system ending, when a status is established in which the cached data is protected according to the second memory protection method, the protection of the cached data according to the first memory protection method and shutting down the first storage controller.

2. The storage system according to claim 1, wherein
the storage system activates the first storage controller when receiving an instruction to complete maintenance work for the first storage controller,
the storage system duplicates the cached data in the memory of the second storage controller to the first storage controller to protect the cached data according to the first memory protection method, and
the storage system discards the log in the storage device.

3. The storage system according to claim 1, wherein, when the second storage controller fails while the first storage controller is shut down, the second storage controller that has recovered from the failure reads the log generated according to the second memory protection method from the storage device and restores the cached data.

4. The storage system according to claim 1, further comprising, as the storage device:
a user drive serving as a final write destination of write data, which is indicated by the write request; and
a log drive that stores the log, wherein
the storage controller writes the log generated according to the second memory protection method to the log drive.

5. The storage system according to claim 1, wherein,
when receiving the write request, the storage system determines whether or not either of the first storage controller and the second storage controller is under maintenance and determines whether or not both of the first storage controller and the second storage controller are in operation,
the storage system protects the cached data according to the first memory protection method unless either of the first storage controller and the second controller is under maintenance, and
the storage system protects the cached data according to the second memory protection method unless either of the first storage controller and the second storage controller is in operation.

6. The storage system according to claim 1, wherein
when the storage system receives a maintenance operation instruction that requires the plurality of storage controllers to be shut down, the second storage controller protects the cached data according to the second memory protection method,
the storage system shuts down the first storage controller,
the storage system activates the first storage controller when receiving an instruction to complete maintenance work for the first storage controller,
the storage system duplicates, to the first storage controller, the cached data in the memory of the second storage controller to protect the cached data according to the first memory protection method,
the storage system discards the log in the storage device, and
the storage system switches the first storage controller and the second storage controller to each other to execute the protection of the cached data from starting of the second memory protection method to the discarding of the log.

7. The storage system according to claim 1, wherein, after protecting the cached data according to the first memory protection method or the second memory protection method, the storage controller returns a write completion response to the host and de-stages the cached data to the storage device after the write completion response.

8. The storage system according to claim 1, wherein, when the storage system receives the maintenance work instruction, the second storage controller writes to the storage device the data in the memory of the second storage controller.

9. A data protection method for a storage system including a nonvolatile storage device and a plurality of storage controllers that control reading and writing to the storage device,
each of the plurality of storage controllers including a processor and a memory,
the storage controller including a first memory protection method, which is a memory duplication method that duplicates data in the memory into the memory of the corresponding storage controller, and a second memory protection method, which is a log backup method that generates a log related to update of the data in the memory and writes the log into the storage device,
the storage controller being capable of storing in the memory a write request from a host to the storage device as cached data,
the data protection method comprising the steps of:
by the storage system, starting, when receiving a maintenance work instruction that requires the first storage controller to be shut down, an operation of protecting the cached data according to the second memory protection method, while the second storage controller protects the cached data according to the first memory protection method; and
by the storage system, ending, when a status is established in which the cached data is protected according to the second memory protection method, the protection of the cached data according to the first memory protection method and shutting down the first storage controller.

10. The data protection method for the storage system according to claim 9, further comprising the steps of:
by the storage system, activating the first storage controller when receiving an instruction to complete maintenance work for the first storage controller;
by the storage system, duplicating the cached data in the memory of the second storage controller to the first storage controller to protect the cached data according to the first memory protection method; and
by the storage system, discarding the log in the storage device.

11. The data protection method for the storage system according to claim 9, wherein, when the second storage controller fails while the first storage controller is shut down, the second storage controller that has recovered from the failure reads the log generated according to the second memory protection method from the storage device and restores the cached data.

12. The data protection method for the storage system according to claim 9, wherein the storage system further includes, as the storage device, a user drive serving as a final write destination of write data, which is indicated by the write request, and a log drive that stores the log,
the data protection method further comprising a step of:
by the storage controller, writing the log generated according to the second memory protection method to the log drive.

13. The data protection method for the storage system according to claim 9, wherein,
when the write request is received, determination is made on whether or not either of the first storage controller and the second storage controller is under maintenance and determination is made on whether or not both of the first storage controller and the second storage controller is in operation,
the cached data is protected according to the first memory protection method unless either of the first storage controller and the second controller is under maintenance, and
the cached data is protected according to the second memory protection method unless either of the first storage controller and the second storage controller is in operation.

14. The data protection method for the storage system according to claim 9, further comprising the steps of:
by the second storage controller, protecting, when the storage system receives a maintenance operation instruction that requires the plurality of storage controllers to be shut down, the cached data according to the second memory protection method;
by the storage system, shutting down the first storage controller;
by the storage system, activating the first storage controller when receiving an instruction to complete maintenance work for the first storage controller;
by the storage system, duplicating, to the first storage controller, the cached data in the memory of the second storage controller to protect the cached data according to the first memory protection method;
by the storage system, discarding the log in the storage device; and
by the storage system, switching the first storage controller and the second storage controller to each other to execute the protection of the cached data from starting of the second memory protection method to the discarding of the log.

15. The data protection method according to claim 9, further comprising the steps of:
by the storage controller, returning, after protecting the cached data according to the first memory protection method or the second memory protection method, a write completion response to the host; and
by the stage controller, de-staging the cached data to the storage device after the write completion response.

16. The data protection method according to claim 9, further comprising a step of:
by the second storage controller, writing to the storage device, when the storage system receives the maintenance work instruction, the data in the memory of the second storage controller.
